(19) United States
(12) Patent Application Publication
(10) Pub. No.: US 2015/0278831 A1
(43) Pub. Date: Oct. 1, 2015

(54) SYSTEMS AND METHODS FOR SERVER ENHANCEMENT OF USER ACTION DATA COLLECTION

(71) Applicants: Eyal Gal, Kfar Saba (IL); Eyal Nathan, Modiin (IL); Vitaly Vainer, Kfar Saba (IL)

(72) Inventors: Eyal Gal, Kfar Saba (IL); Eyal Nathan, Modiin (IL); Vitaly Vainer, Kfar Saba (IL)

(21) Appl. No.: 14/323,312

(22) Filed: Jul. 3, 2014

Related U.S. Application Data
(60) Provisional application No. 61/971,713, filed on Mar. 28, 2014.

(51) Int. Cl. G06Q 30/02

(52) U.S. Cl. CPC G06Q 30/0201

(57) ABSTRACT

According to some embodiments, a business server may receive a user action reporting message from a remote mobile client device associated with a user. The business server may automatically determine supplemental context-based information associated with the received user action reporting message. The supplemental context-based information may then be stored at the business server.

### CROSS-REFERENCE TO RELATED APPLICATIONS

The present application claims the benefit of U.S. Provisional Patent Application 61/971,713 entitled “SYSTEMS AND METHODS FOR SERVER ENHANCEMENT OF USER ACTION DATA COLLECTION” and filed Mar. 28, 2014. The entire contents of that application are incorporated herein by reference.

### FIELD

Some embodiments relate to systems and methods associated with actions taken by a user on a client device. More specifically, some embodiments are directed to systems and methods wherein a server may enhance the collection of user action data.

### BACKGROUND

Users may interact and/or exchange information with a business enterprise application. For example, a user might access a remote business enterprise server via his or her smartphone to view a schedule of upcoming meetings. In some cases, the user or “client side” device (e.g., smartphone) may store information associated with the user's actions. For example, an application vendor might log user actions at client devices and later review those actions do determine which application features are the most popular. In other cases, a web-based service might collect information about user actions on a client device. For example, a web-based analytics service might track user actions to help determine which Uniform Resource Locator (URL) links are rarely selected by users. Similarly, a web-based analytics service might use pattern recognition techniques to automatically suggest a book or product to a user based on his or her actions (and the prior actions of similar users). There are limits, however, to such approaches. For example, the client device is typically battery operated, and the extra processing associated with enhancing information may consume a substantial amount of power. Moreover, the amount and types of information available at the client device or web service may be limited, and, as a result, certain types of enhancements may not be possible. For example, the client device or web service may be unable to determine if a particular telephone number is associated with a user's manager.

Accordingly, methods and mechanisms to efficiently, accurately, and/or automatically facilitate the enhancement of user action data collection may be provided in accordance with some embodiments described herein.

### SUMMARY

Some embodiments provide a system, method, program code and/or means to facilitate the enhancement of user action data collection. According to some embodiments, a business server may receive a user action reporting message from a remote mobile client device associated with a user. The business server may automatically determine supplemental context-based information associated with the received user action reporting message. The supplemental context-based information may then be stored at the business server.

With these and other advantages and features that will become hereinafter apparent, further information may be obtained by reference to the following detailed description and appended claims, and to the figures attached hereto.

### BRIEF DESCRIPTION OF THE DRAWINGS

FIG. 1 is a block diagram of a system architecture according to some embodiments.

FIG. 2 is a flow diagram of a process in accordance with some embodiments.

FIG. 3 is an example of a business server enhancing user action data according to some embodiments.

FIG. 4 is an example of a business server enhancing user action data according to another embodiment.

FIG. 5 is a flow diagram of a process in accordance with some embodiments.

FIG. 6 is an example of a business server enhancing user action data according to some embodiments.

FIG. 7 is a block diagram of the internal architecture of a smartphone according to some embodiments.

FIG. 8 is a block diagram of a smartphone operating system according to some embodiments.

FIG. 9 is a block diagram of the software architecture of a smartphone according to some embodiments.

FIG. 10 is a block diagram of an apparatus according to some embodiments.

FIG. 11 illustrates a portion of an enricher definitions database that might be stored in accordance with some embodiments.

FIG. 12 illustrates a portion of an enricher registrations database that might be stored in accordance with some embodiments.

FIG. 13 illustrates a portion of a supplemental information database that might be stored in accordance with some embodiments.

FIG. 14 is a diagram of a system architecture according to some embodiments.

### DETAILED DESCRIPTION

Users may interact and/or exchange information with a business enterprise application. For example, a user might access a remote business enterprise server via his or her smartphone perform an action to view the time and location of an upcoming meeting. In some cases, the user or “client side” device (e.g., smartphone) may store information associated with the user's actions. For example, the client device might log the phone number, time and date, and duration of incoming telephone calls. Similarly, a web-based analytics service might store information about user actions performed at the client device.

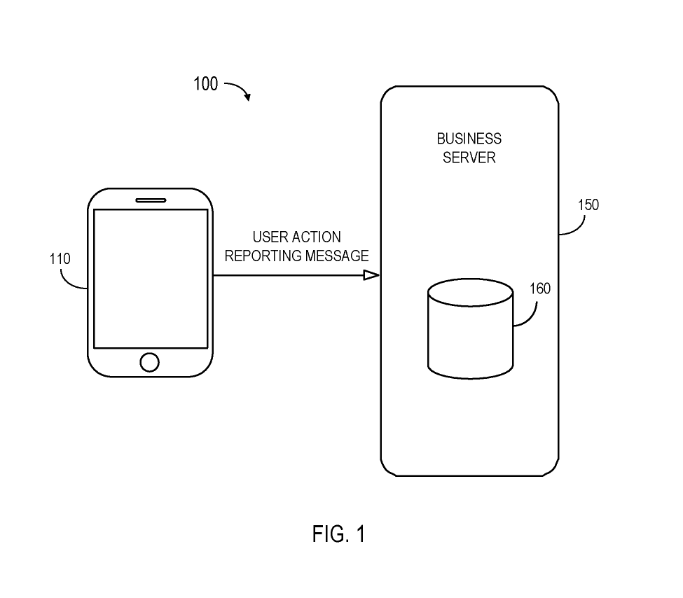

There are limits, however, to such an approach. For example, the client device is typically battery operated, and the extra processing associated with enhancing information may consume a substantial amount of power (e.g., to analyze an article read by the user on the client device to determine the subject matter of the article). Moreover, the amount and types of information available at the client device or web-based service may be limited, and, as a result, certain types of enhancements may not be possible. For example, the client device or web-based service may be unable to determine a job description associated with a person who is attending a meeting being viewed by a user. In addition, an enterprise associated with a business server may want to customize user interfaces based on past actions taken by that user and/or analyze user action data associated with a substantial number of different users. For example, the enterprise might be interested in determining what percentage of users viewing a list of tasks scroll to the bottom of the list (so that all tasks have been viewed by the user). These types of customizations and business intelligence analytics cannot be practically implemented at the client device or a web-based service. To address such problems, FIG. 1 is a block diagram of a system 100 according to some embodiments. The system 100 includes a mobile user device 110 that can exchange business enterprise information, such as meeting requests, contact information, email application messages, search queries, and operations associated with a business work flow. The mobile user device 110 might be associated with, by ways of example only, a mobile computer, a smartphone, a gaming device, a navigation device, a music player, a wristwatch, or eyeglasses having a lens based display.

The mobile user device 110 may exchange business enterprise information with a business server 150. By way of example only, the business server 150 might be associated with an Enterprise Resource Planning (ERP) server, a business services gateway, a HyperText Transfer Protocol (HTTP) server, and/or an Advanced Business Application Programming (ABAP) server.

According to some embodiments, the business server 150 may directly communicate with one or more remote mobile user devices 110 via the Internet. The mobile user devices 110 may include one or more processors to receive electronic files and/or to execute applications and/or components (e.g., a plug-in that is integrated to a smartphone).

Note that FIG. 1 represents a logical architecture for the system 100 according to some embodiments, and actual implementations may include more or different components arranged in other manners. Moreover, each system described herein may be implemented by any number of devices in communication via any number of other public and/or private networks. Two or more of devices may be located remote from one another and may communicate with one another via any known manner of network(s) and/or a dedicated connection. Further, each device may comprise any number of hardware and/or software elements suitable to provide the functions described herein as well as any other functions. Other topologies may be used in conjunction with other embodiments.

Any of the devices illustrated in FIG. 1, including the business server 150 and mobile user device 110, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

All systems and processes discussed herein may be embodied in program code stored on one or more computer-readable media. Such media may include, for example, a floppy disk, a CD-ROM, a DVD-ROM, magnetic tape, OR solid state Random Access Memory (RAM) or Read Only Memory (ROM) storage units. Embodiments are therefore not limited to any specific combination of hardware and software.

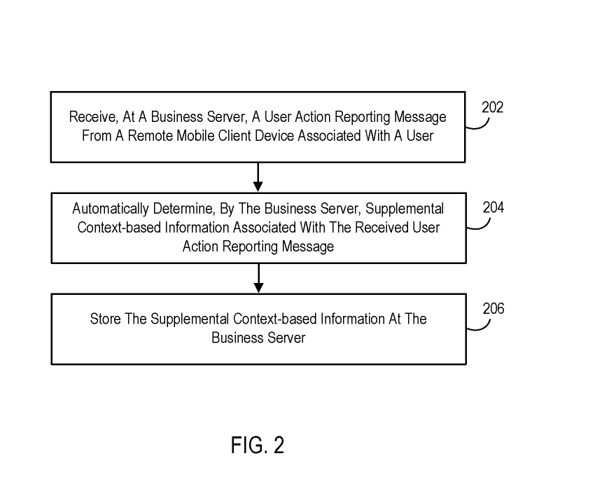

According to some embodiments, the mobile user device 110 may transmit a user action reporting message to the business server 150. Moreover, the business server 150 may automatically determine supplemental context-based information associated with the received user action reporting message, and store that information locally in a database 160. For example, FIG. 2 is a flow diagram of a process 200 that might be associated with the illustration of the system 100 of FIG. 1 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At 202, a business server may receive a user action reporting message from a remote mobile client device associated with a user. The user action reporting message may include, for example, a user identifier (e.g., an employee number), an application identifier or type, an object identifier, a message identifier (e.g., a Microsoft Exchange message identifier), a contact identifier, a search query, and/or a meeting identifier. For example, the user action reporting message might indicate that the user has opened an application, deleted a contact, or scrolled through a list of tasks. Note that the client device might not get any response after sending the user action reporting message to the business server (other than, in some embodiments, a simple “OK” or “error” protocol indication). This may help ensure that the response from the business server is relatively quick. A user might execute multiple actions in a relatively short amount of time, and, as a result, response times may be kept relatively short so that client applications will not hang due to pending requests for action reporting.

At 204, the business server may automatically determine supplemental context-based information associated with the received user action reporting message. For example, the supplemental context-based information may indicate that the user has opened an email message from his or her manager or indicate that he or she has completed a task associated with a customer he or she is not typically responsible for. Other examples of supplemental context-based information include a user title, a job description, communication information, office location information, and employee hierarchy information (e.g., indicating who works for who within an enterprise). According to some embodiments, this automatic determination is performed in substantially real time. According to other embodiments, the determination may be performed a periodic basis (e.g., a batch of received user actions may be processed each night). According to some embodiments, the determination may be associated with a separate process which is, for example, triggered by a scheduled task. Note that the determination of supplemental context-based information may include retrieving the supplemental context-based information from an external third-party service (e.g., a stock exchange or news service).

At 206, the supplemental context-based information may be stored at the business server. In this way, the supplemental information may be later analyzed to provide business information insights (e.g., to learn that users open tasks assigned to them by their managers 87% of the time and tasks assigned by colleagues only 55% of the time), to make recommendations to the user, or for any other purpose. According to some embodiments, the supplemental information may further be associated with transmitting an alert, generating a report, establishing a communication, and/or adjusting a workflow.

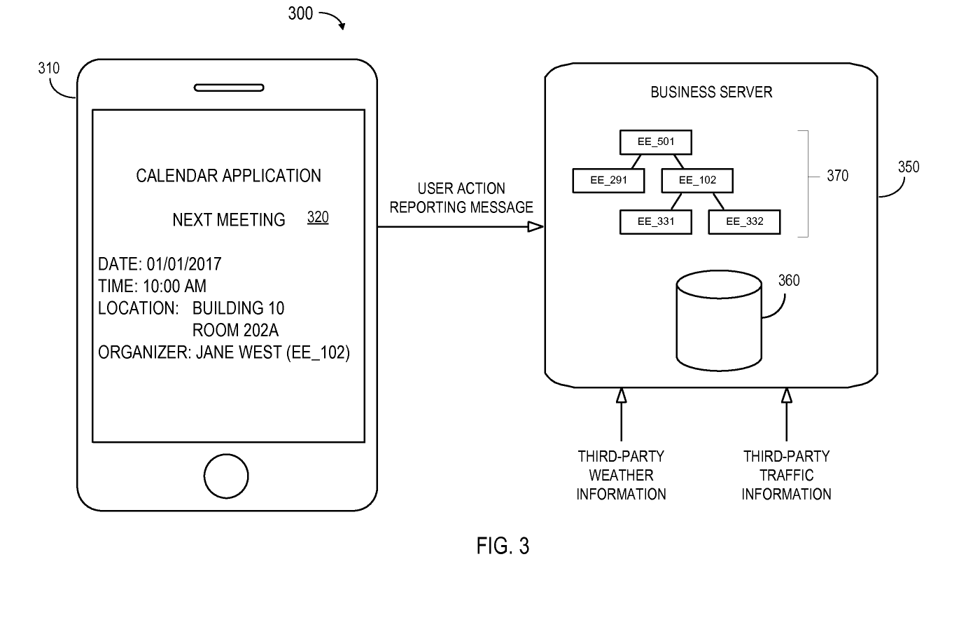

Consider, for example, FIG. 3 which is an example 300 of a business server 350 enhancing user action data according to some embodiments. In this case, a user has interacted with his or her smartphone 310 to open a calendar application to view information about the next scheduled meeting 320. As a result, the smartphone 310 automatically transmits a user action reporting message to the business server 350. According to some embodiments, the business server 350 receives third-party weather and traffic information. According to some embodiments, the business server 350 can also access internal enterprise hierarchy information 370 indicating who each employee works for. This information might be used, for example, to later analyze how often employees attend meetings organized by their immediate supervisor or how likely employees are to attend meetings more than one mile away from their current location when weather conditions are poor. Any of this type of information can then be stored in and retrieved from the local database 360.

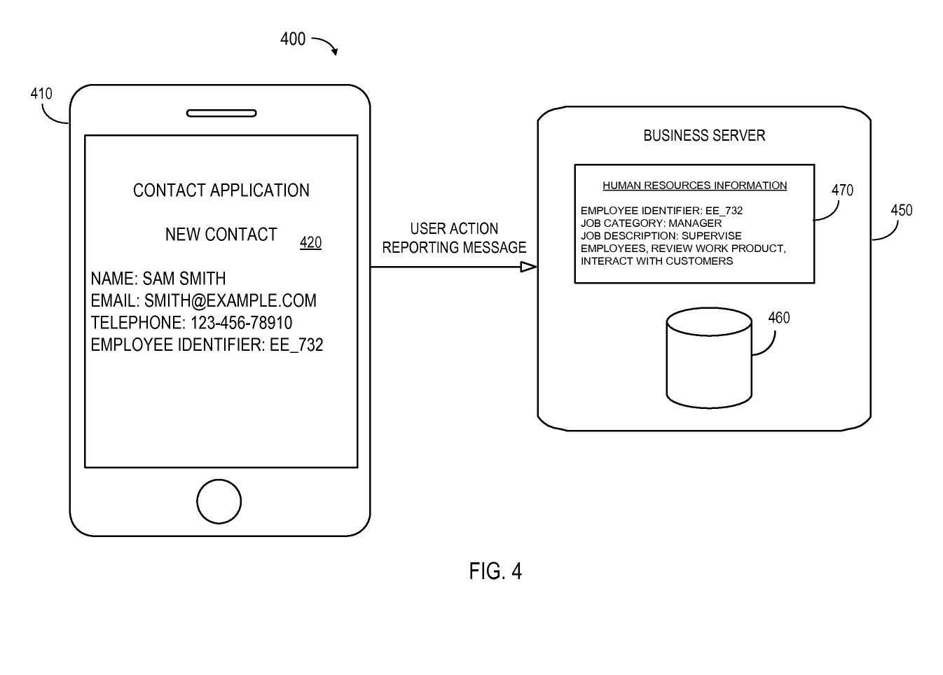

FIG. 4 is an example 400 of a business server 450 enhancing user action data according to another embodiment. In this case, a user has interacted with his or her smartphone 410 to enter information about a new contact 420 into a contact application. As a result, the smartphone 410 transmits a user action reporting message to the business server 450. According to some embodiments, the business server 450 can also access human resources information 470, including job descriptions. This supplemental job description information may then be stored in and retrieved from a local database 460. In this example, an enterprise might determine, for example, how often employees include a telephone number when adding a new client as a contact.

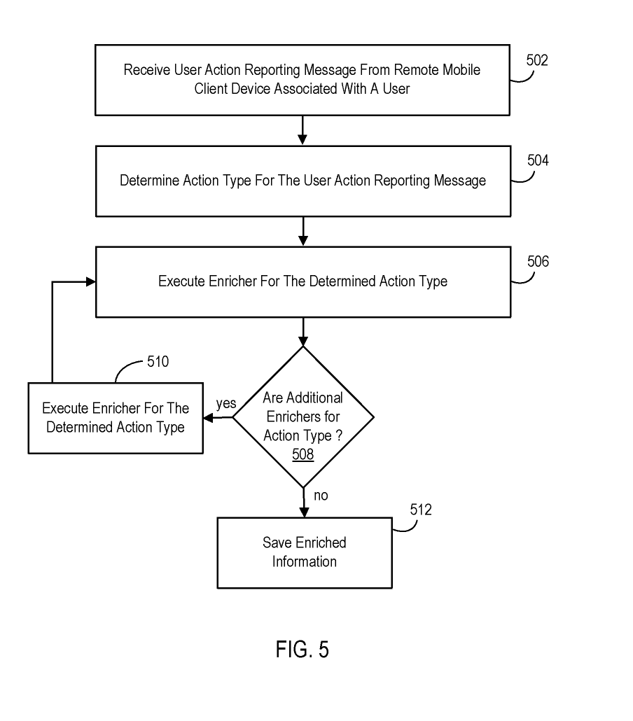

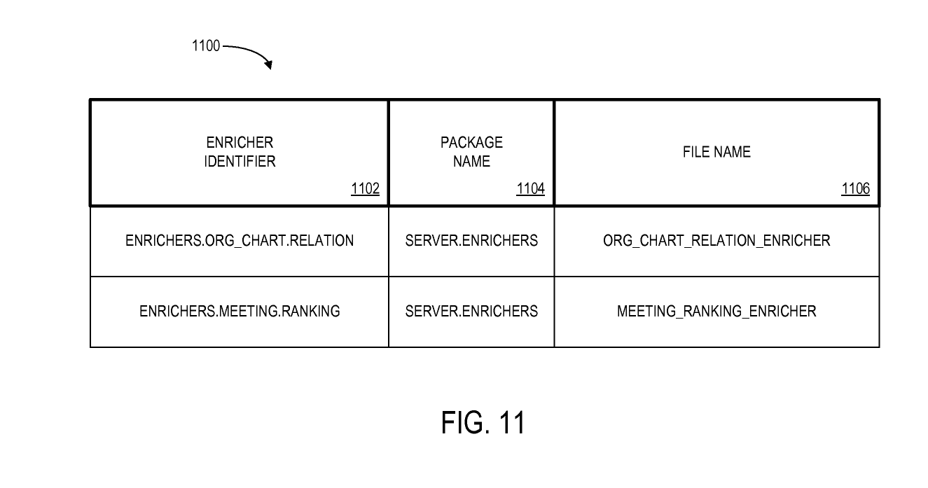

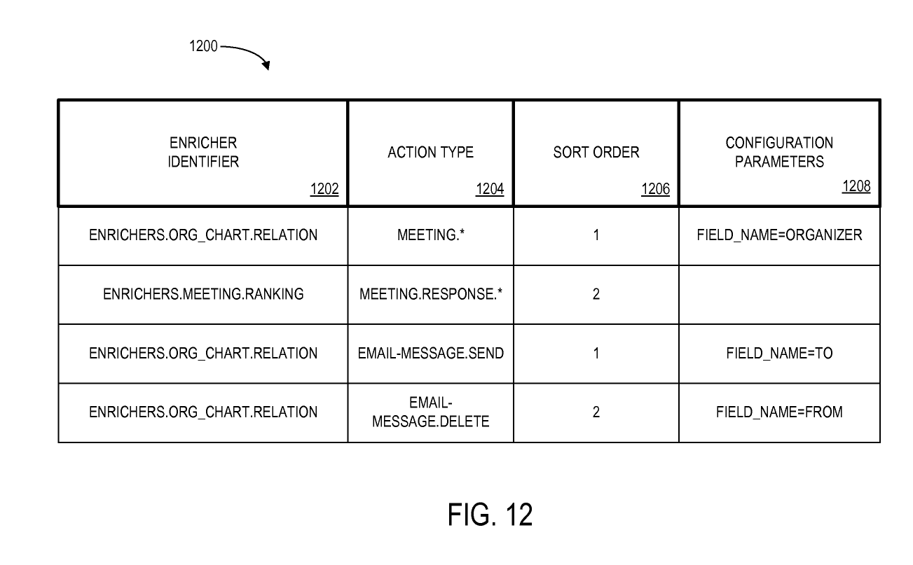

FIG. 5 is a flow diagram of a process in accordance with some embodiments. At 502, a user action reporting message is received from a remote mobile client device associated with a user. The user action might be associated with, for example, the user launching an application, selecting a specific entry in a table or list displayed in the application, navigating between different screens of application, triggering a search using a search box in a user interface, activating a button or icon, etc. An action type for the user activity message may then be determined at 504. For example, a message may be associated with an action related to a meeting, an action related to an email, a user scrolling through a list of items, an action related to a contact, a change to a purchase order, etc. According to some embodiments, supplemental context-based information is determined using an extension mechanism to register at least one additional enrichment plugin via a unique key. In this case, an appropriate enricher for the determined action type may be executed at 506. If there are no additional enrichers for actions of this type at 508, the enriched information may be saved at 512. If there are additional enrichers for actions of this type at 508, they may be executed at 506. An example of such an approach is described with respect to FIGS. 11 and 12.

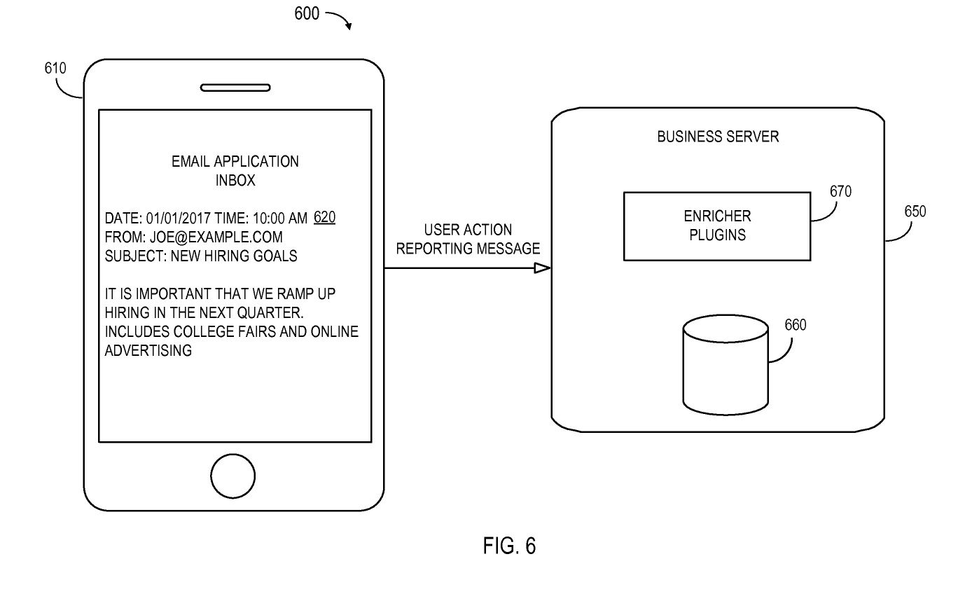

FIG. 6 is an example 600 of a business server 650 enhancing user action data according to some embodiments. In this case, a user has interacted with his or her smartphone 610 to perform an action associated with an email message 620 in an email application. As a result, the smartphone 610 transmits a user action reporting message to the business server 650 (including an action type of “view email message”) which, as a result, executes one or more enricher plugins 670 associated with the appropriate action type. According to some embodiments, one or more of these enricher plugins 670 automatically identifies one or more topics associated with email message and stores the information in a local database 660. The stored information may then be used for later analysis. For example, an enterprise might want to determine what percentage of employee emails in a particular month were associated with customer complaints.

Note that data analytics associated with detailed statistics about user habits and actions may play an important role in allowing for any type of future analysis. One aspect of such an analysis may be a trustworthy assessment of the current user context. For example, it might be determined that users who receive tasks from their immediate supervisor typically perform an action to assign those tasks a “high” priority. As a result, the enterprise might determine that “high” priority should be the default value in such situations. As another example, an icon might be altered, moved, or deleted based on overall usage patterns throughout the enterprise.

Increasing the amount of collected data may lead to improved business information insights. Attempting to collect and analyze large amounts of data at the client device, however, can be impractical. For example, a mobile client is limited both by the need for an efficient battery usage, and by CPU performance. In addition, in order to have an efficient transformation of the data, an access to external accessory services might be required and this may not be feasible in the client device (e.g., a mobile phone may be outside an organization's internal network). For example, when storing data about an action related to a meeting, such as viewing a meeting or sending a response to a meeting request, it may be more relevant (for later analysis) to indicate whether the organizer is the user's co-worker or manager instead of a simply an employee number (e.g., as it may exist at an exchange-server). This kind of transformation may require access to an internal organization chart service, which may not be possible from the client device or a web-based service.

According to some embodiments described herein, in addition to any data gathering that is done on the client-side, the gathering and enrichment process is continued on the server according to current user context. On the server, which may be equipped with higher computational power and better access to internal and external services (as compared to the client side), more sophisticated business-logic for may be implemented for manipulating and enriching the data. For example, each time the client device indicates that the user has performed an action associated with a user identifier (e.g., organizer, attendees, and recipients) the server may enrich the data with an appropriate user title and affiliation relative to the current user of the client device (e.g., is the organizer his or her manager?). This kind of “offline collection” may decrease the client side load because the computations are performed by the server. In addition, these computations don't block the client device, which can continue work flows smoothly. The server may delay these computations for a number of hours, according to some embodiments (e.g., a nightly batch run might be performed by the server).

According to any of the embodiments described herein, an activity reporting mechanism may be designed to record user actions. Note that user actions may be performed on different kinds of objects (e.g., a user may perform an action to accept a meeting, scroll through a list of tasks, delete a contact, or launch an application). Each kind of action may be enriched with different additional properties and information. For example, an action associated with a meeting object may be enriched with additional data about the participants, location, etc., while an action associated with a contact object may be enriched with information from organization's internal systems, such as human resources information (job description. etc.), communication details, and/or an office location from an address book.

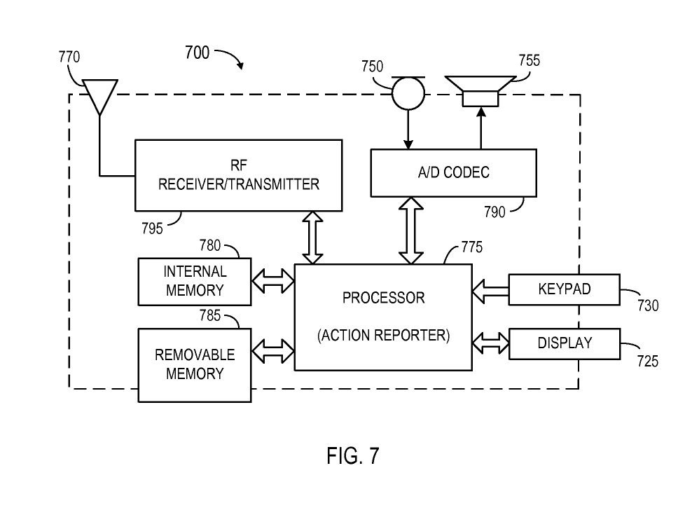

According to some embodiments, a user's client side device transmits a user action reporting message to a remote business server. For example, FIG. 7 is a block diagram of the internal architecture of a smartphone 700 according to some embodiments. As shown, cellular telephone 700 includes processor 775, which may be a conventional microprocessor, microcontroller and/or digital signal processor (DSP) or other control circuit conventionally provided in a cellular telephone. Processor 775 is shown in communication with keypad 730 and touch screen display 725 to receive user actions.

Also included in the cellular telephone 700 are internal memory 780 and removable memory 785. Internal memory 780 may include one or more of ROM (read only memory), RAM (random access memory, e.g., static RAM), and flash memory. Removable memory 785 may comprise a flash memory, a Subscriber Identity Module (SIM) card or any other removable memory that is or becomes known. Cellular telephone 700 may therefore be equipped with an interface for physically receiving and transferring data to and from removable memory 785.

Note that information about a user action reporting message might be stored in the internal memory 780 and/or the removable memory 785. Memories 780 and 785 may also store program code that is executable by processor 775 to control telephone 700. The program code may include but is not limited to operating system program code, application program code, device driver program code, and database connector program code. The program code may include code to cause cellular telephone 700 to perform functions that are described herein. In some embodiments, the program code is executable to transmit user action reporting messages to a remote business server as appropriate.

Memories 780 and 785 may also store data used in the operation of cellular telephone 700. Such data may include phone numbers, addresses, access codes, stored audio files, text corresponding to the stored audio files, and other data. Some or all of the data may be read-only, while other of the data may be rewritable.

Analog/digital coder/decoder (A/D codec) 790 is also in communication with processor 775. A/D codec 790 may receive analog signals from microphone 750 (including speech input from a user), convert the analog signals to digital signals, and pass the digital signals to processor 775. Conversely, processor 775 may transmit digital signals to A/D codec 790, which converts the digital signals to analog signals and passes the analog signals to speaker 755. Speaker 755 then emits sound based on the analog signals.

RF receiver/transmitter 795 is operatively coupled to antenna 770 that may transmit the user action reporting messages. RF receiver/transmitter 795 may, in accordance with conventional practices, comprise a combination of two or more different receive/transmit modules (not separately shown) that operate in accordance with mutually different radio communication protocols to provide various services for the cellular telephone 700. For example, receiver/transmitter 795 may operate in accordance with one radio communication protocol to provide conventional two-way service for cellular telephone 700, and may operate in accordance with another radio communication protocol to provide PoC service for cellular telephone 700.

Those in the art will understand that the block diagram of FIG. 7 is simplified in a number of ways. For example, all power and power management components of cellular telephone 700 are omitted from the diagram. Also, some embodiments may employ an internal architecture somewhat different or completely different from that shown in FIG. 7.

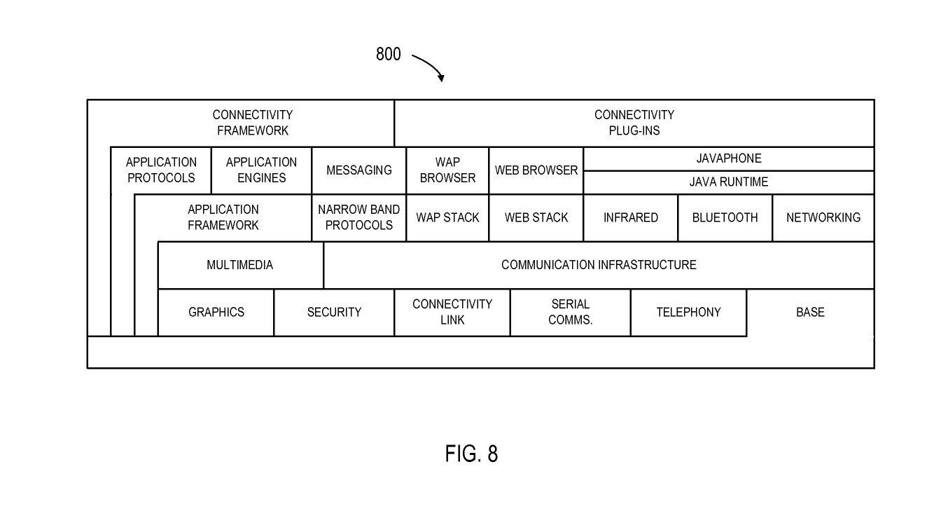

FIG. 8 is a block diagram of an operating system architecture 800 that may be used in conjunction with some embodiments. Architecture 800 corresponds to the Symbian™ cellular telephone operating system but any suitable operating system may be used in conjunction with some embodiments, including those not intended and/or usable with cellular telephones. Suitable operating systems according to some embodiments include but are not limited to iOS™, Palm OS™, Windows Mobile™, RIM Blackberry™, and operating systems suitable for devices capable of transmitting text messages (e.g., PDAs and digital media players). According to some embodiments, the application engines portion of the architecture includes at least one engine to facilitate transmission of user action reporting messages to an enterprise server as appropriate.

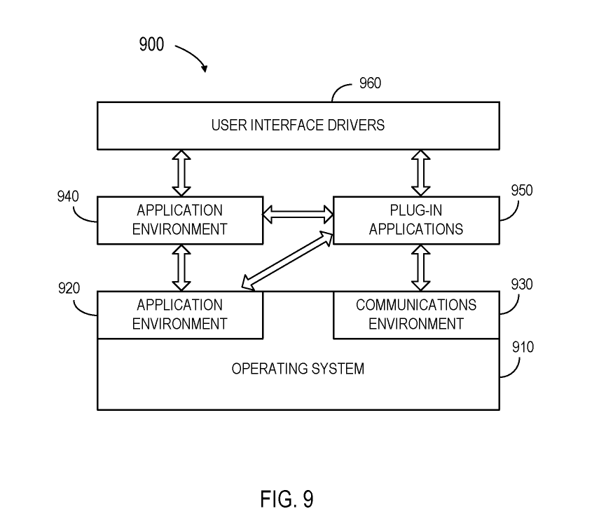

FIG. 9 is a block diagram of a general software architecture 900 that may be used within a smartphone in conjunction with some embodiments. Architecture 900 may operate to detect communication events initiated at or received by the telephone and facilitate transmission of user action reporting messages to an enterprise server as appropriate.

Architecture 900 includes operating system 910, which may comprise architecture 800 of FIG. 8. In such a case, application environment 920 and communications environment 930 may correspond, respectively, to the connectivity framework and the connectivity plug-ins of architecture 800. Generally, application environment 920 provides a platform by which another application environment 940 may interface with operating system 910. Application environment 940 may comprise a C, Java™ or any other programming environment. As such, plug-in applications 950 may be written in Java or C for execution by cellular telephone. Plug-in applications 950 may also be written for the application interface provided by application environment 920.

Communications environment 930 provides plug-in applications 950 with access to the communications functionality of operating system 910. This functionality may include text messaging, Web browsing and of course telephone communication. Plug-in applications 950 may also transmit data and commands to and receive input from user interface drivers 960 for control of the user interfaces of the smartphone. According to some embodiments, the architecture 900 may facilitate transmission of user action reporting messages to an enterprise server as appropriate.

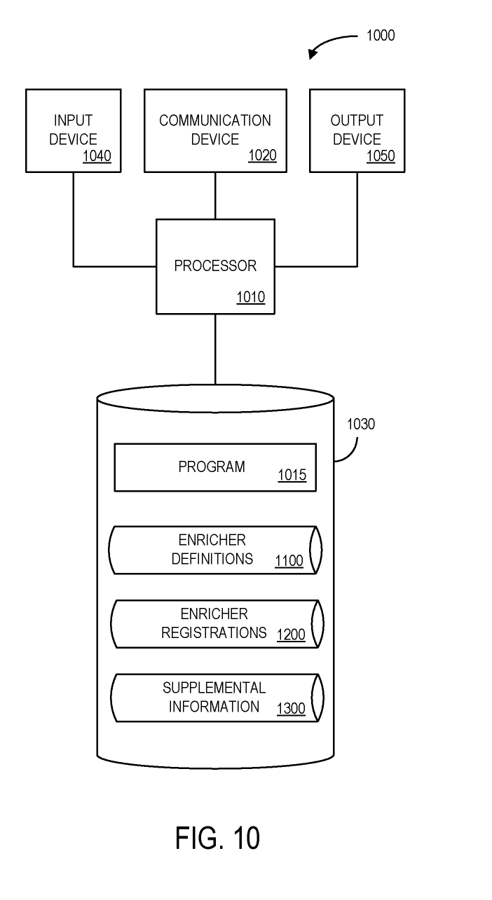

FIG. 10 is a block diagram overview of an apparatus 1000 according to some embodiments. The apparatus 1000 may be, for example, associated with a business server. The apparatus 1000 comprises a processor 1010, such as one or more commercially available Central Processing Units (CPUs) in the form of one-chip microprocessors, coupled to a communication device 1020 configured to communicate via a communication network (not shown in FIG. 10). The communication device 1020 may be used, for example, as an input path to receive information about building maps and/or business process steps. The apparatus 1000 further includes an input device 1040 (e.g., keyboard or computer mouse to enter enricher information) and an output device 1050 (e.g., a display or printer to generate enricher reports).

The processor 1010 communicates with a storage device 1030. The storage device 1030 may comprise any appropriate information storage device, including combinations of magnetic storage devices (e.g., a hard disk drive), optical storage devices, and/or semiconductor memory devices. The storage device 1030 stores a program 1015 for controlling the processor 1010. The processor 1010 performs instructions of the program 1015 and thereby operates in accordance with any of the embodiments described herein. For example, the processor 1010 may receive a user action reporting message from a remote mobile client device associated with a user. The processor 1010 may automatically determine supplemental context-based information associated with the received user action reporting message. The supplemental context-based information may then be stored by the processor 1010.

The program 1015 may be stored in a compressed, uncompiled and/or encrypted format. The program 1015 may furthermore include other program elements, such as an operating system, a database management system, and/or device drivers used by the processor 1010 to interface with peripheral devices.

As used herein, information may be “received” by or “transmitted” to, for example: (i) the apparatus 1000 from another device; or (ii) a software application or module within the apparatus 1000 from another software application, module, or any other source.

In some embodiments (such as shown in FIG. 10), the storage device 1030 further stores enricher definitions 1100, enricher registrations 1200, and supplemental information 1300 (e.g., supplementing information about interactions between a user and a client device). Examples of databases that may be used in connection with the apparatus 1000 will now be described in detail with respect to FIGS. 11 through 13. Note that the databases described herein are only examples, and additional and/or different information may be stored therein. Moreover, various databases might be split or combined in accordance with any of the embodiments described herein.

Referring to FIG. 11, a table is shown that represents the enricher definitions database 1100 that may be stored at the apparatus 1000 according to some embodiments. The table may include, for example, entries identifying business logic and/or enhancement steps that may be performed. The table may also define fields 1102, 1104, 1106 for each of the entries. The fields 1102, 1104, 1106 may, according to some embodiments, specify: an enricher identifier 1102, a package name 1104, and a file name 1106. The information in the enricher definitions database 1100 may be created and updated, for example, based on information received from a system designer or customer.

The enricher identifier 1102 may be, for example, a unique alphanumeric code identifying business logic or enhancement steps that may be performed. For example, the “ENRICHERS.ORG_CHART.RELATION” enricher identifier 1102 may be associated with logic to add a work relationship (e.g., manager, subordinate, or co-worker) to a person identified by his or her email address in a property of a user action message, such as the “From” property of actions related to email messages. The package name 1104 and file name 1106 may be used to locate the executable code associated with the business logic or enhancement steps.

Referring to FIG. 12, a table is shown that represents the enricher registrations database 1200 that may be stored at the apparatus 1000 according to some embodiments. The table may include, for example, entries identifying which enricher plugins should be executed when a user action reporting message is received. The table may also define fields 1202, 1204, 1206, 1208 for each of the entries. The fields 1202, 1204, 1206, 1208 may, according to some embodiments, specify: an enricher identifier 1202, an action type 1204, a sort order 1206, and configuration parameters 1208. The information in the enricher registrations database 1200 may be created and updated, for example, based on information received from a system designer or customer.

The enricher identifier 1202 may be, for example, a unique alphanumeric code identifying business logic or enhancement steps that may be performed and may be identical to, or associated with, the enricher identifier 1102 stored in the enricher definitions database 1100. The action type 1204 may indicate which actions should trigger execution of the enricher identifier 1202. For example, a user action reporting message associated with a meeting response (e.g., an action accepting or declining a meeting invitation) triggers two of the enricher identifiers 1202 illustrated in FIG. 12, while one associated with other actions on a meeting object, such as viewing a meeting in a calendar application, triggers only one. Note that the “ENRICHERS.ORG_CHART.RELATION” enricher identifier 1202 is triggered in both cases, as it is associated with all user action messages associated with meetings by using a wildcard “*.” The sort order 1206 defines a sequence in which enricher plugins should be executed (when more than one is trigged by an action type 1204). The configuration parameters 1208 may represent, for example, optional inputs that may be used to control the enricher plugin. For example, the “ENRICHERS.ORG_CHART.RELATION” plugin may be instructed to provide org.chart relationship information for specific properties of an action as illustrated in FIG. 12. This enables the usage of a single plugin implementation for multiple action types using different configurations—the “ENRICHERS.ORG_CHART.RELATION” plugin is used for actions associated with both email messages and meetings, while providing the supplemental information to different properties of each user action type 1204.

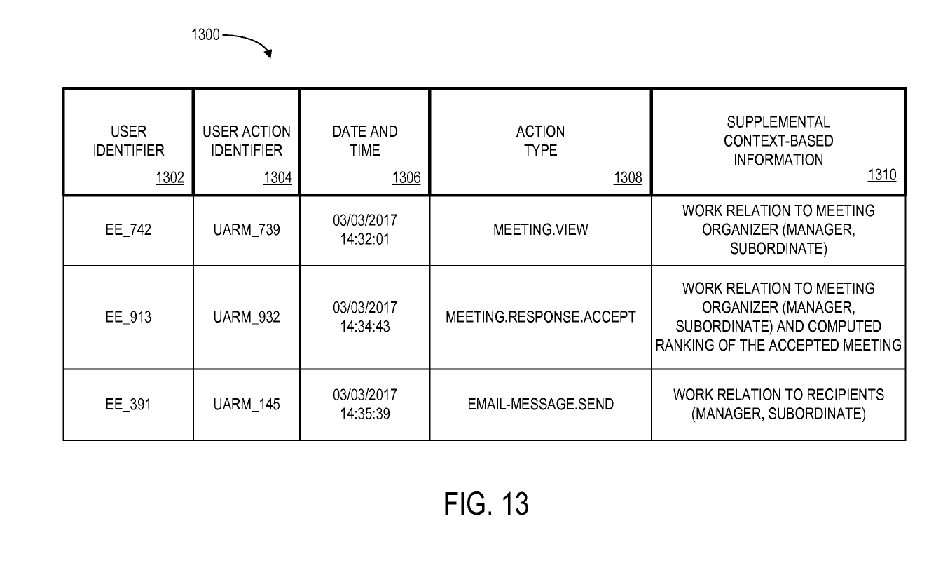

Referring to FIG. 13, a table is shown that represents the supplemental information database 1300 that may be stored at the apparatus 1000 according to some embodiments. The table may include, for example, entries identifying enhanced and enriched information about user actions. The table may also define fields 1302, 1304, 1306, 1308, 1310 for each of the entries. The fields 1302, 1304, 1306, 1308, 1310 may, according to some embodiments, specify: a user identifier 1302, a user action identifier 1304, a date and time 1306, an action type 1308, and supplemental context-based information 1310. The information in the map database 1300 may be automatically created and updated, for example, by the apparatus 1000 as the user performs actions (or on a batch basis).

The user identifier 1302 may be, for example, a unique alphanumeric code identifying a user of a client side device (e.g., smartphone). The user action identifier 1304 may be associated with a particular user action reporting message received by the apparatus 1000 at the particular date and time 1306. The action type 1308 may describe the type of action being reported (e.g., the user opened a new contact, the user accessed his or her email account, etc.). The supplemental context-based information 1310 may indicate the enhancement or enrichment made by the apparatus 1310. The supplemental context-based information 1310 may, for example, indicate automatically identified work relationships, a computerized ranking of an accepted meeting, a job description, etc.

In this way, server architecture may be designed in a way that supports an extension for the action enrichment mechanism. Such an approach may allow for the registration of additional enrichers plugins by unique key (e.g., exchange.meeting.enricher) in the registrations database 1200. Subsequently, according to the data in the user action reporting message, the plugins may be invoked to enrich the data of the appropriate action type (e.g. the ENRICHERS.MEETING.RANKING” enricher may be invoked for actions of type “MEETING.RESPONSE.*”).

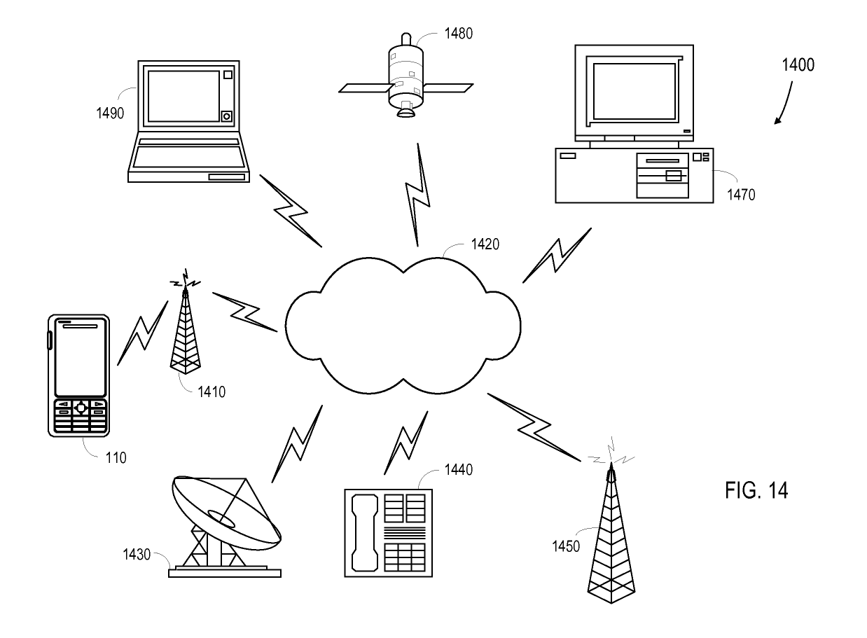

FIG. 14 is a partial diagram of a communication architecture 1400 according to some embodiments. In particular, a mobile communication device 110 (in this example, a smartphone) is shown in communication with tower 1410, which may forward the transmission to communication network 1420 according to governing protocols. Communication network 1420 may include any number of devices and systems for transferring data, including but not limited to local area networks, wide area networks, telephone networks, cellular networks, fiber-optic networks, satellite networks, infra-red networks, radio frequency networks, and any other type of networks which may be used to transmit information between devices. Additionally, data may be transmitted through communication network 1420 using one or more currently- or hereafter-known network protocols, including but not limited to Asynchronous Transfer Mode (ATM), Internet Protocol (IP), Hypertext Transfer Protocol (HTTP) and Wireless Application Protocol (WAP).

Devices 1430 through 1490 are examples of some devices that may be a part of or in communication with communication network 1420. As such, devices 1430 through 1490 may receive communication events, either as intended recipients or as network nodes for passing messages. Devices 1430 through 1490 include satellite transmitter/receiver 1430, landline telephone 1440 having a subscriber line interface circuit to receive a telephone line (e.g., a cordless phone or a corded phone), communication tower 1450, desktop computer or server 1470, satellite 1480 and portable computing device 1490. Note the server 1470 might be associated with, for example, any of the embodiments described herein (e.g., to enhance collection of user action data via the mobile communication device 110). Any other suitable devices may be used as a transmitting device or a receiving device in conjunction with some embodiments.

The elements of system 1400 may be connected differently than as shown. For example, some or all of the elements may be connected directly to one another. Embodiments may include elements that are different from those shown. Moreover, although the illustrated communication links between the elements of system 1400 appear dedicated, each of the links may be shared by other elements. Elements shown and described as coupled or in communication with each other need not be constantly exchanging data. Rather, communication may be established when necessary and severed at other times or always available but rarely used to transmit data. According to some embodiments, actions by a user may be collected and enhanced by a program executing at the server 1470 or on demand in a computing cloud environment (located with or accessed via the communication network 1420).

The system 1400 may use one or more models to facilitate user action enhancement by the server. Such models may be created, for example, by a model designer or architect via a platform that creates and extends applications for enterprise interaction scenarios. Designers may be able to define a model (represented in a specified XML schema) that represents a useful improvement to user action data collection.

Thus, some embodiments may establish methods and mechanisms to efficiently, accurately, and/or automatically enrich the collection of user action data. The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to business systems and databases, note that embodiments may be associated with other types of enterprise data. For example, enrichment and enhancement of collected user action data with financial, governmental, educational, and/or medical processes and systems may be facilitated in accordance with any of the embodiments described herein.

Moreover, while embodiments have been illustrated using particular types of tables and databases, embodiments may be implemented in any other of a number of different ways. For example, some embodiments might be associated with third-party and/or publically available information, such as flight or train schedules, stock prices, etc. available via web sites. Further, while examples have been provided for particular types of user actions, note that any embodiment may be associated with any type of user action (e.g., spoken search terms).

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer implemented method, comprising:
receiving, at a business server, a user action reporting message from a remote mobile client device associated with a user;
automatically determining, by the business server, supplemental context-based information associated with the received user action reporting message; and
storing the supplemental context-based information at the business server.

2. The method of claim 1, wherein the client device is associated with at least one of: (i) a mobile computer, (ii) a smartphone, (iii) a gaming device, (iv) a navigation device, (v) a music player, (vi) a wristwatch, and (vi) a pair of eyeglasses.

3. The method of claim 1, wherein the user action reporting message includes at least one of: (i) a user identifier, (ii) an application identifier, (iii) an object identifier, (iv) a contact identifier, (v) a search query (vi) a meeting identifier, (vii) a message identifier, and (viii) an action type.

4. The method of claim 1, wherein supplemental information associated with a plurality of users is analyzed to determine business intelligence information.

5. The method of claim 1, wherein the supplemental context-based information is determined using an extension mechanism to register at least one additional enrichment plugin via a unique key.

6. The method of claim 1, wherein the supplemental context-based information is associated with at least one of: (i) traffic information, (ii) weather information, (iii) map information, (iv) a user title, (v) a job description, (vi) communication information, (vii) office location information, and (viii) employee hierarchy information.

7. The method of claim 1, wherein said automatic determination is performed at least one of: (i) in substantially real time, and (ii) on a periodic basis.

8. The method of claim 1, wherein said automatic determination includes:
retrieving the supplemental context-based information from an external third-party service.

9. The method of claim 1, wherein the remote enterprise server is associated with at least one of: (i) an Enterprise Resource Planning application, (ii) a Customer Relationship Management application, and (iii) an Advanced Business Application Programming application.

10. A non-transitory, computer-readable medium storing program code executable by a computer processor to perform a method, the method comprising:
receiving, at a business server, a user action reporting message from a remote mobile client device associated with a user;
automatically determining, by the business server, supplemental context-based information associated with the received user action reporting message; and
storing the supplemental context-based information at the business server.

11. The medium of claim 10, wherein the client device is associated with at least one of: (i) a mobile computer, (ii) a smartphone, (iii) a gaming device, (iv) a navigation device, (v) a music player, (vi) a wristwatch, and (vi) a pair of eyeglasses.

12. The medium of claim 10, wherein the user action reporting message includes at least one of: (i) a user identifier, (ii) an application identifier, (iii) an object identifier, (iv) a contact identifier, (v) a search query (vi) a meeting identifier, and (vii) a message identifier, and (viii) an action type.

13. The medium of claim 10, wherein supplemental information associated with a plurality of users is analyzed to determine business intelligence information.

14. The medium of claim 10, wherein the supplemental context-based information is determined using an extension mechanism to register at least one additional enrichment plugin via a unique key.

15. A business server, comprising:
a communication port to receive a user action reporting message from a remote mobile client device associated with a user; and
a processor coupled to the communication port and configured to: (i) determine supplemental context-based information associated with the received user action reporting message, and (ii) store the supplemental context-based information at the business server

16. The business server of claim 15, wherein the supplemental context-based information is associated with at least one of: (i) traffic information, (ii) weather information, (iii) map information, (iv) a user title, (v) a job description, (vi) communication information, (vii) office location information, and (viii) employee hierarchy information.

17. The business server of claim 15, wherein said determination is performed at least one of: (i) in substantially real time, and (ii) on a periodic basis.

18. The business server of claim 15, wherein said determination includes retrieving the supplemental context-based information from an external third-party service.

19. The business server of claim 15, wherein the remote enterprise server is associated with at least one of: (i) an Enterprise Resource Planning application, (ii) a Customer Relationship Management application, and (iii) an Advanced Business Application Programming application.
